(19) United States
(12) Patent Application Publication
(10) Pub. No.: US 2010/0110364 A1
(43) Pub. Date: May 6, 2010

(54) METHOD AND DEVICE FOR SPECKLE REDUCTION

(75) Inventors: Hein Johannes Teunissen, Enschede (NL); Lingli Wang, Bad Kreuznach (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/513,395

(22) PCT Filed: Nov. 6, 2007
(86) PCT No.: PCT/IB2007/054487

§ 371 Date: May 4, 2009

(30) Foreign Application Priority Data
Nov. 7, 2006 (EP) 06123576.8

(51) Int. Cl. G02F 1/13

(52) U.S. Cl. 349/201

(57) ABSTRACT

A device and method for speckle reduction are disclosed, wherein a coherent laser beam (3) is expanded by using a beam expander (7). The expanded beam is subsequently allowed to pass through a variable optical element (11), which may comprise a liquid crystal cell, and applies a diffractive function on the expanded beam. The cross-section of the beam is then reduced by means of a collimator (17). The speckle pattern of the collimated beam is varied quickly, such that the extent of annoying speckle, which is perceived when the beam is projected on a surface, is reduced.

### FIELD OF THE INVENTION

The present invention relates to a device and a method for reducing the perception of speckle generated by a laser beam.

### BACKGROUND OF THE INVENTION

Such a device is described e.g. in U.S. Pat. No. 5,313,479, which discloses a display system using coherent light, wherein speckles are reduced by means of a diffuser that is rotated or vibrated.

However, devices of this type tend to be complex and thus expensive due to the use of mechanically moveable parts.

### OBJECT AND SUMMARY OF THE INVENTION

It is therefore an object of the present invention to provide a device and a method which are capable of reducing the perception of speckle without the use of moveable parts.

This object is achieved by means of a device for reducing the perception of speckle produced by a laser beam as defined in claim 1, and by a corresponding method as defined in claim 9.

More specifically, the device comprises a beam expander which is arranged to produce an expanded beam from an incident beam, the expanded beam having an increased cross-sectional area as compared to the incident beam, a variable optical element which is arranged in the path of the expanded beam, wherein the optical element is arranged to apply a diffractive function on at least a sub-portion of the expanded beam, thereby producing a diffracted beam, wherein the diffractive function varies over time, and a beam collimator which is arranged to produce a collimated beam from the diffracted beam, the collimated beam having a decreased cross-sectional area as compared to the diffracted beam.

This device is capable of applying a diffractive function on the light beam which varies in such a way that the speckle pattern is changed quickly. This does not remove the speckle pattern, but makes it less visible and thus less disturbing to the human eye. Mechanically moveable parts are not needed.

The optical element may comprise a first liquid crystal, LC, cell, containing an LC material and having a grating structure, and electrodes to influence the contained LC material. By virtue of the grating structure, the LC molecules will be arranged to provide a strong diffractive effect, and the electrodes can influence this effect to a great extent. The optical element may further comprise a second cell, and the first and second cells may be controlled individually. This makes it possible to change the diffractive effect of the optical element more quickly.

If two cells are used, these cells may have mutually different grating periods and/or grating orientations so as to vary the diffractive effect more substantially.

As a first alternative, the optical element may comprise an LC cell containing an LC material and having a grating structure, and a plurality of electrodes interconnected in groups to influence the contained LC material. This makes it possible to arrange the LC molecules in structures with more than one grating period while using a single cell.

As a second alternative, the optical element may comprise a plurality of LC cells, each cell containing an LC material and having a grating structure, and electrodes to influence the contained liquid crystal material, wherein each cell affects a sub-portion of the expanded beam.

The device may be included in a laser projection system or in a lighting system.

The method comprises the steps of: producing an expanded beam from an incident beam, the expanded beam having an increased cross-sectional area as compared to the incident beam, applying a diffractive function on at least a sub-portion of the expanded beam, thereby producing a diffracted beam, wherein the diffractive function varies over time, and producing a collimated beam from the diffracted beam, the collimated beam having a decreased cross-sectional area as compared to the diffracted beam. The method provides advantages and may be varied in conformity with the device.

These and other aspects of the invention are apparent from and will be elucidated with reference to the embodiments described hereinafter.

### BRIEF DESCRIPTION OF THE DRAWING

FIG. 1 shows schematically a device for reducing the perception of speckle produced by a laser beam.

FIG. 2 shows a variable optical element for use in the device of FIG. 1.

FIG. 3 shows a first alternative variable optical element for use in the device of FIG. 1.

FIG. 4 shows a second alternative variable optical element for use in the device of FIG. 1.

### DESCRIPTION OF EMBODIMENTS

A method and device for reducing the perception of speckle generated by a laser beam will now be described.

Speckle is a phenomenon which occurs when a highly coherent light beam, such as a laser beam, is scattered by a rough surface having random surface properties, such as paper, fabric or a painted wall. Different parts of the scattered light add up to a strongly fluctuating light pattern, due to interference resulting in intensity peaks and valleys. This speckle phenomenon may be experienced as very annoying, e.g. if the laser beam is used in a laser projection system. A projected image may then have a “granular” appearance.

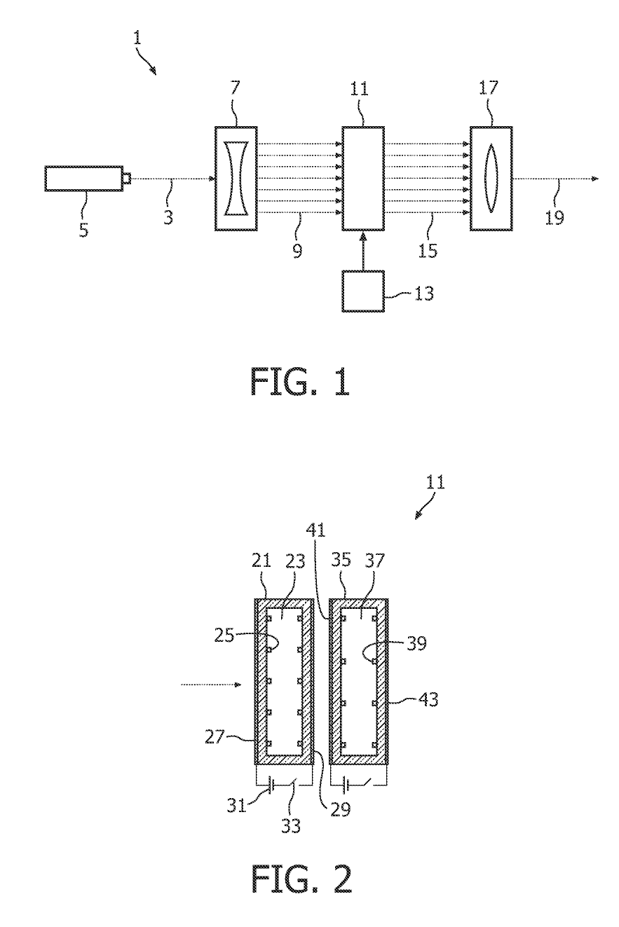

FIG. 1 shows schematically a device for reducing the perception of speckle produced by a laser beam.

The device 1 receives an incident beam 3 which is generated by means of a laser light source 5, e.g. a laser diode, a VCSEL (Vertical Cavity Surface Emitting Laser), a frequency-converted solid-state laser, a gas laser, or the like. Note that the light source 5 is not part of the device 1. Temporally and spatially, the incident beam 3 is highly coherent and, if projected on a rough surface, it will generate an annoying speckle pattern.

The incident beam 3 is fed into a beam expander 7 which is generally illustrated by a single concave lens. However, the skilled person will be aware of different optical systems which are capable of expanding a beam, i.e. increasing its cross-section, and usually incorporate a number of lenses and/or mirrors. The beam 9 outputted from the beam expander may thus be called an expanded beam.

A variable optical element 11 is placed in the path of the expanded beam 9. The diffractive/optical element 11, which will be described in greater detail hereinafter, is arranged to apply a diffractive function on the expanded beam 9. The entire width of the beam may be affected by the diffractive function, or at least a sub-portion of the beam. The optical element is arranged to provide a diffractive function that varies over time. This variation is provided by means of a control unit 13 which is connected to the optical element 11.

If the diffractive function varies at a frequency of about 60 Hz or more, the speckle patterns may be removed to a great extent when a beam is finally projected on a surface. The speckle pattern is thus still present in the projected beam, but since the pattern is varied, it is perceived by the human eye to a lesser extent. However, also frequencies of less than 60 Hz will produce some effect. The beam 15 outputted from the optical element 11 may be called a diffracted beam 15.

The diffracted beam continues to a beam collimator 17, indicated by a convex lens. Similarly as with the beam expander 7, the collimator 17 may be realized in different ways, as is well known to the skilled person. In general, the collimator 17 produces a collimated beam 19 from the diffracted beam 15. The collimated beam 19 has a decreased cross-sectional area as compared to the diffracted beam 15.

The cross-sectional area of the collimated beam 19 may correspond to that of the incident beam 3, although this is not necessary.

By virtue of the varying diffractive function of the optical element 11, the speckle pattern of the collimated beam 19 changes quickly, such that the viewer does not see the speckle pattern at all when the collimated beam is projected on a surface, or perceives the annoying speckle as being reduced as compared to the situation in which the incident beam 3 is projected.

The collimated beam 19 may now be used in a number of applications, e.g. in a laser projection system, as a spotlight, in automotive front lighting systems, and the like.

FIG. 1 also illustrates a corresponding method for reducing the perception of speckle produced by a laser beam, the method comprising the steps of producing an expanded beam from an incident beam, the expanded beam having an increased cross-sectional area as compared to the incident beam, applying a diffractive function on at least a sub-portion of the expanded beam, thereby producing a diffracted beam, wherein the diffractive function varies over time, and producing a collimated beam from the diffracted beam, the collimated beam having a decreased cross-sectional area as compared to the diffracted beam.

FIG. 2 shows schematically and in a cross-section a variable optical element 11 for use in the device of FIG. 1. The element comprises a first thin liquid crystal cell 21 which contains a liquid crystal, LC, material 23.

The inner surface of the cell 21 has a grating structure 25 which is provided as a fine surface structure that, in a relaxed state, makes the LC molecules order themselves in a grating-like structure with a specific orientation (in the plane of the LC cell) and spacing period. This grating-like structure of the LC molecules in the LC cell 21 will substantially diffract light passing through the cell in the direction indicated by the arrow in FIG. 2. Note that the grating structure is microscopic. Regarding this aspect, FIG. 2 is of course not drawn to scale. As the LC material affects only one type of polarization, the polarized nature of the laser light is used.

The cell 21 further comprises electrodes 27, 29 which are placed on opposite sides of the LC material. The electrodes may be made of a transparent material (e.g. ITO, Indium Tin Oxide) and are used to influence the LC material 23 contained in the cell. When a voltage is applied between the electrodes 27, 29, as indicated by a voltage source 31 and a switch 33, the LC molecules are forced by the electric field to leave their grating-like structure to some extent. This may e.g. be achieved by the control unit 13 indicated in FIG. 1. Then, the diffractive effect of the LC cell 21 is substantially changed. The refractive index is changed as well. If the diffractive effect is changed at a sufficiently high rate, e.g. 60 Hz or more, the human eye will perceive a reduced speckle.

By e.g. switching the electric field on and off, the diffractive function of the LC cell will thus be varied over time. Of course, it is also possible to let the applied voltage vary continuously, such that the diffractive effect is changed smoothly.

The optical element 11 shown in FIG. 2 is further enhanced by a second liquid crystal cell 35, which is similar to the first cell 21. The second cell thus contains a liquid crystal material 37 and has a grating structure 39, and electrodes 41, 43 to influence the contained liquid crystal material. The first and second cells are individually controllable, i.e. the first cell may or may not be switched on while the second is switched off, and vice versa. Therefore, even if only on and off-states are used, four combinations are possible (on-on, on-off, off-on, and off-off). The diffractive effect may thus vary by twice the frequency of the applied electric fields, which is particularly useful if the LC material is “slow”. The cells may have different grating periods, e.g. 50 μm in the first cell 21 and 60 μm in the second. Alternatively, or in combination with this difference, the cells may also have different grating orientations. These differences make the above-mentioned diffractive modes even more mutually different. Of course, more than two cells may be used.

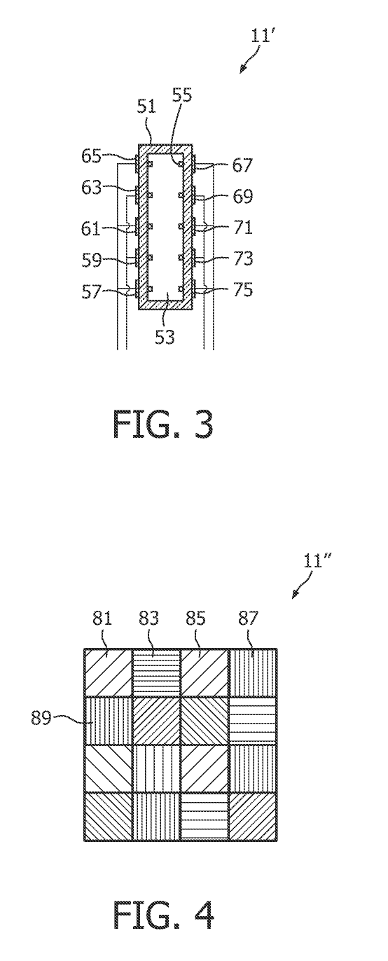

FIG. 3 shows in a cross-section a first alternative variable optical element for use in the device of FIG. 1. In this case, the optical element 11′ comprises a single liquid crystal cell 51 which contains a liquid crystal material 53. The cell has a grating structure 55 which will influence the LC material. The difference with e.g. the first cell 21 in FIG. 2 is that the electrodes on a flat surface of the cell are divided into separate portions which are interconnected in groups. Thus, separate electrodes 57, 59, 61, 63, and 65 are placed on one side of the cell and are interconnected in a first group 57, 61, 65 and a second group 59, 63 of electrodes. Each electrode may be coordinated with a sub-structure in the grating structure. Similarly, two groups 67, 71, 75 and 69, 73 of electrodes are provided on the other side. Similarly to the combination of two cells in FIG. 2, this allows a number of different diffractive functions to be achieved by applying different voltages to the different groups of electrodes. The application of different combinations of voltages to the different groups of electrodes may be used to change the grating structure of the LC molecules by changing the grating spacing period.

Two cells as illustrated in FIG. 3 may of course be combined, as can one cell as illustrated in FIG. 3 and one illustrated in FIG. 2, etc.

FIG. 4 is a front view of a second alternative variable optical element for use in the device of FIG. 1.

In this case, the optical element 11″ comprises a plurality of liquid crystal cells 81, 83, 85, 87, 89, etc. which are arranged in an array to influence different sub-portions of the expanded beam 9, as illustrated in FIG. 1. Each cell contains a liquid crystal material as described hereinbefore. As illustrated in FIG. 4, the cells may have different grating spacings and gratings, and are individually controllable by means of electrodes. Therefore, different portions of the expanded beam will be influenced by different, and varying, diffractive effects before they are combined to a collimated beam by the collimator. This will very effectively reduce any speckle perceived by the human eye.

In summary, a device and method for speckle reduction are disclosed, wherein a coherent laser beam is expanded by using a beam expander. The expanded beam is subsequently allowed to pass through a variable optical/diffractive element, which may comprise a liquid crystal cell, and applies a diffractive function on the expanded beam. The cross-section of the beam is then reduced by means of a collimator. The speckle pattern of the collimated beam is varied quickly, such that the extent of annoying speckle, which is perceived when the beam is projected on a surface, is reduced.

1. Device for reducing speckle produced by a laser beam, the device comprising:
a beam expander, arranged to produce an expanded beam (9) from an incident beam (3), the expanded beam having an increased cross-section area as compared to the incident beam;
a variable optical element comprising at least one liquid crystal cell containing a liquid crystal material and having a grating structure and electrodes to influence the contained liquid crystal material, wherein the optical element is arranged in the path of the expanded beam to apply a diffractive function on at least a sub-portion of the expanded beam, thereby producing a diffracted beam (15), wherein the diffractive function varies over time; and
a beam collimator arranged to produce a collimated (19) beam from the diffracted beam (15), the collimated beam having a decreased cross-section area as compared to the diffracted beam.

2. (canceled)

3. Device according to claim 2, wherein the optical element (11) further comprises a second liquid crystal cell (35), containing a liquid crystal material (37) and having a grating structure (39) and electrodes (41, 43) to influence the contained liquid crystal material, wherein the first and second cells are individually controllable.

4. Device according to claim 3, wherein the grating periods and/or the grating orientations of the first and second cells are mutually different.

5. Device according to claim 1, wherein the optical element (11′) comprises a liquid crystal cell, containing a liquid crystal material and having a grating structure and a plurality of electrodes interconnected in groups to influence the contained liquid crystal material.

6. Device according to claim 1, wherein the optical element (11″) comprises a plurality of liquid crystal cells (81, 83, 85, 87, 89), each cell containing a liquid crystal material and having a grating structure and electrodes to influence the contained liquid crystal material, wherein each cell affects a sub-portion of the expanded beam.

7-8. (canceled)

9. Method for reducing experienced speckle produced by a laser beam, the method comprising:
producing an expanded beam from an incident beam, the expanded beam having an increased cross-section area as compared to the incident beam;
applying a diffractive function, using a variable optical element comprising at least one liquid crystal cell, on at least a sub-portion of the expanded beam, thereby producing a diffracted beam, wherein the diffractive function varies over time; and
producing a collimated beam from the diffracted beam, the collimated beam having a decreased cross-section area as compared to the diffracted beam.
